(19) United States
(12) Patent Application Publication
(10) Pub. No.: US 2010/0124391 A1
(43) Pub. Date: May 20, 2010

(54) Growable multi-degree ROADM

(76) Inventors: Mark David Feuer, Colts Neck, NJ (US); Sheryl Leigh Woodward, Holmdel, NJ (US)

Correspondence Address: AT& T LEGAL DEPARTMENT - Monka;ATTN: PATENT DOCKETING, ROOM 2A - 207, ONE AT & T WAY, BEDMINSTER, NJ, 07921, US

(21) Appl. No.: 12/313,250

(22) Filed: Nov. 18, 2008

(51) Int. Cl. G02B 6/28

(52) U.S. Cl. 385/24

(57) ABSTRACT

A multi-degree expandable reconfigurable optical add drop multiplexer (ROADM) based on a wavelength-selective crossconnect (WSXC), and method for upgrading the same. The WSXC generally consists of an outer layer of optical fan-out devices, and an outer layer of optical fan-in devices. At least one inner layer of optical fan-out or fan-in devices, including at least one wavelength switch, is disposed between the outer layer of optical fan-out devices and the outer layer of optical fan-in devices in a cascaded arrangement relative to the outer layers. At least one output port of an optical fan-out device in the outer layer of optical fan-out devices is connected to an input port of an optical device in the at least one inner layer, and at least one output port of an optical device in the at least one inner layer is connected to an input port of an optical fan-in device in the outer layer of optical fan-in devices.

### FIELD OF THE INVENTION

The present invention relates generally to optical networks, and more particularly, to a methodology and system that facilitates network growth through expandable multi-degree reconfigurable optical add-drop multiplexers (ROADMs).

### BACKGROUND OF THE INVENTION

In less than a decade, the state of the art in fiber-optic transport systems has progressed from simple point-to-point chains of optically amplified fiber spans to massive networks with hundreds of optically amplified spans connecting transparent add-drop nodes spread over transcontinental distances. Cost reduction has been the primary driver for this transformation, and the primary enabler has been the emergence of the reconfigurable optical add/drop multiplexer (ROADM) as a network element (NE).

Exploiting the inherent wavelength granularity of wavelength-division multiplexing (WDM), an optical add/drop multiplexer (OADM) allows some WDM channels (also referred to as wavelengths) to be dropped at a node, while the others traverse the same node without electronic regeneration. Previously, it was necessary to terminate line systems at each node served, and then regenerate the wavelength signals destined for other nodes. The ability to optically add/drop a fraction of a system's wavelengths at a node was first achieved using fixed OADMs. These were constructed from optical filters, and by enabling wavelengths to optically bypass nodes and eliminate unnecessary regeneration, they provided significant cost savings. However, because traffic growth is inherently unpredictable, it is advantageous for the add-drop capability to be reconfigurable.

ROADMs provide many advantages beyond the savings achieved by optically bypassing nodes. In the future, multi-degree ROADMs with adequate reconfiguration speeds may enable shared-mesh restoration at the optical layer. Shared mesh restoration significantly reduces the number of wavelength channels that must be installed as redundant protection circuits. ROADMs also provide operational advantages. Because ROADMs can be reconfigured remotely, they enable new wavelength channels to be installed by simply placing transponders at the end points, without needing to visit multiple intermediate sites. In addition to these cost-saving benefits, ROADMs will enable new services. For example, if transponders are preinstalled, then new circuits can be provided on-demand. The rapid network reconfiguration provided by ROADMs could also become an enabler of dynamic network services, such as switched video for IPTV. For all of these reasons, ROADMs will continue to have a significant effect on the design of optical networks.

Generally, a ROADM is defined as a NE that permits the active selection of add and drop wavelengths within a WDM signal, while allowing the remaining wavelengths to be passed through transparently to other network nodes. Thus, the simplest ROADM will have two line ports (East and West) that connect to other nodes, and one local port (add/drop) that connects to local transceivers. In today's networks, optical links are typically bidirectional, so each line port represents a pair of fibers. When using conventional local transceivers that can process only a single wavelength at a time, the number of fibers in the add/drop port sets the maximum number of wavelengths that can be added or dropped at a given node.

A ROADM with only two line ports (East and West) is referred to as a two-degree ROADM. Practical networks also have a need for multi-degree ROADMs that can serve more than two line ports. In addition to providing local add/drop of from each of its line ports, the multi-degree ROADM must be able to interconnect any individual wavelength from one line port to another, in a reconfigurable way. The degree of a multi-degree ROADM is equal to the number of line-side fiber pairs that it supports (it does not include the number of fiber pairs used in the add/drop portion of the ROADM).

Many designs for multi-degree ROADMs are based on modules known as wavelength selective crossconnects (WSXCs). A WSXC is a module which accepts WDM optical signals into each of its plurality of inputs, then routes each incoming wavelength to one of its plurality of outputs in a selectable and reconfigurable way. As suggested by the word ‘crossconnect’, any incoming wavelength can be individually switched to different output ports as needed. An incoming wavelength may have access to the full set of outputs, or it may be restricted to a plural subset of outputs. Conversely, the output signal at a given wavelength on a given output port may be chosen from different input ports, either the full set of input ports or a plural subset of the input ports. FIG. 1 shows two ROADM designs of degree three utilizing a WSXC. In FIG. 1a, both the line-side signals and the local add/drop signals pass through the WSXC 100a. The local add/drop signals are demultiplexed and multiplexed via multiplexer/demultiplexers (mux/demux) 102a. In FIG. 1b, the line-side signals pass through the WSXC 100b, but the local add/drop signals are passed around the WSXC 100b via power splitter(PS)/combiners(PC) 104b coupled to mux/demux 102b. Note that for FIG. 1b, each add/drop fiber is assigned to a specific line-side direction (port). In contrast, the design of FIG. 1a allows each wavelength from any add/drop fiber to be ‘steered’ to different line-side ports.

A full ROADM provides add/drop (de)multiplexing of any arbitrary combination of wavelengths supported by the system with no maximum, minimum, or grouping constraints. A partial ROADM only has access to a subset of the wavelengths, or the choice of the first wavelength introduces constraints on other wavelengths to be dropped. The drop fraction of a ROADM is the maximum number of wavelengths that can be simultaneously dropped, divided by the total number of wavelengths in the WDM signal. If a given add or drop fiber is capable of handling any wavelength, it is said to be colorless. If a given add or drop fiber can be set to address any of the line ports (e.g., east or west for a 2-degree ROADM), it is said to be “steerable.” A NE is characterized as “directionally separable” if there is no single failure that will cause a loss of add/drop service to any two of its line ports.

An example of a WSXC 200 for connecting three fiber pairs (three bidirectional ports) in the ROADM of type shown in FIG. 1b is depicted in FIG. 2. The WSXC 200 includes three power splitters (PSs) 202 and wavelength selective switches (WSSs) 204. The PSs 202 and WSSs 204 in the WSXC 200 are coupled to PSs 202, power combiners 203 and amplifiers 206 in the ROADM. Any incoming wavelength can be routed to either of two output fibers. For example, a wavelength coming from the East port can be sent out through the West port or the South port. The design of FIG. 2 does not allow loopback, the process by which a wavelength entering from the East port can be sent back out on the output fiber of the same (East) port. Some other WSXC designs, do support loopback.

FIG. 3 depicts a multi-degree ROADM 300 that supports colorless, steerable add/drop functionality, based on a WSXC core. The ROADM 300 comprises a plurality of 1×8 power splitters (PSs) 302 and 8×1 WSSs 304. A transponder bank 306 is coupled to a tunable multiplexer (MUX) 308 and an input port of a first of power splitters 302, and a tunable demultiplexer (DMUX) 310, which is coupled to the output port of a WSS 304. Similarly, a transponder bank 312 is coupled to a tunable MUX 314 connected to an input port of a second of power splitters 302, and a tunable DMUX 316 connected to an output port of a WSS 304. This configuration has a maximum degree M=9 where M=N+1 for a WSS having N×1 ports. The maximum degree M will be reduced by one if the ROADM is required to support loopback from the input fiber of a given degree to the output fiber of the same degree.

FIG. 4 is a schematic of a ROADM 400 similar to that of FIG. 3, where a WSS is substituted for each PS. The ROADM 400 comprises a plurality of 1×8 WSSs 402 and 8×1 WSSs 404. A transponder bank 406 is coupled to a tunable multiplexer (MUX) 408 and an input port of a first of WSSs 402, and a tunable demultiplexer (DMUX) 410, which is coupled to the output port of a first of WSSs 404. Similarly, a transponder bank 412 is coupled to a tunable MUX 414 connected to an input port of a second of WSSs 402, and a tunable DMUX 416 connected to an output port of a second of WSSs 404. As with the ROADM of FIG. 3, this configuration has a maximum degree M=9 where M=N+1 for WSS having 1×N at the input (402) and N×1 ports on the output 404, assuming that loopback is not required.

Carriers wish to deploy systems in the most cost-effective manner possible. Today, it is far more cost-effective to initially deploy the minimal amount of equipment that can smoothly evolve to meet future needs, rather than to deploy a fully loaded system configuration from the very beginning. Currently and for the foreseeable future, transponders make up the dominant cost of a fully loaded optical communication system. If a full set of transponders were included in the initial deployment, then a substantial cost would be incurred before the network had sufficient traffic to support the expense. Therefore, systems are routinely designed to permit incremental deployment of transponders on an as-needed basis. Similar considerations also apply to multiplexers, although the economic drivers are not as strong. In general, modular growth will be supported whenever the additional cost and complication of upgrading to higher capacity in the future is small compared to the financial impact of a full equipment deployment at startup. By designing this pay-as-you-grow approach into ROADMs, the network itself can grow in a cost-effective manner. Traditional networks grow by adding and interconnecting stand-alone line systems, incurring substantial cost and complexity. By using ROADMs that allow for modular deployment of additional ports, network growth can benefit from both the equipment and operational efficiencies of integrating line systems as they are needed into a seamless network. Because networks are deployed over the course of years, carriers prefer to be able to grow the nodes of the network from terminals or amplifiers, into 2-degree ROADMs, and eventually into multi-degree ROADMs. This not only allows the expense to be spread out over years, it also enables the network designers to respond to unforeseen traffic growth patterns.

For ROADMs based on WSXCs, the degree of the ROADM is dependent on the degree of the WSXC module. It would therefore be desirable to provide a new type of WSXC that can be scaled to large degree. It would also be desirable to provide a method of upgrading the WSXC after installation, increasing the number of degrees to accommodate growth in traffic being carried by the fiber optic network.

### SUMMARY OF THE INVENTION

In accordance with an aspect of the invention, there is provided a wavelength-selective crossconnect (WSXC), comprising: an outer layer of optical fan-out devices, each of the outer layer of optical fan-out devices having an input port and a plurality of output ports; an outer layer of optical fan-in devices, each of the outer layer of optical fan-in devices having an output port and a plurality of input ports; and at least one inner layer of optical devices disposed between the outer layer of optical fan-out devices and the outer layer of optical fan-in devices, wherein at least one output port of an optical fan-out device in the outer layer of optical fan-out devices is connected to an input port of an optical device in the at least one inner layer, and at least one output port of an optical device in the at least one inner layer is connected to an input port of an optical fan-in device in the outer layer of optical fan-in devices. To achieve the reconfigurable wavelength routing required of the WSXC, the at least one inner layer of optical devices includes at least one WSS.

The fan-out devices in the outer layer may comprise a power splitter or 1×N wavelength selective switch (WSS), and the fan-in devices in the outer layer may comprise a power combiner or N×1 WSS. The optical devices in the at least one inner layer may comprise 1×N or N×1 WSSs, as either a fan-out or fan-in layer.

In accordance with one aspect of the invention, the at least one inner layer comprises a first inner layer and a second inner layer of optical devices: the first inner layer of optical devices comprising a plurality of optical fan-out devices arranged in a cascade with respect to the outer layer of optical fan-out devices, each of the fan-out devices in the first inner layer comprising an input port and a plurality output ports; the second inner layer of optical devices comprising a plurality of optical fan-in devices arranged in a cascade with respect to the outer layer of optical fan-in devices, each of the fan-in devices in the second inner layer comprising a plurality of input ports and an output port, each of the optical fan-out devices in the outer-layer being coupled to an optical fan-out device in the first inner layer, an optical fan-in device in the second inner layer, or an optical fan-in device in the outer layer of optical fan-in devices, and each of the optical fan-in devices in the outer layer being coupled to an optical fan-in device in the second inner layer, an optical fan-out device in the first inner layer, or an optical fan-out device in the outer layer of optical fan-out devices.

In accordance with another aspect of the invention, there is provided a method for upgrading a WSXC comprising an outer layer of optical fan-out devices, each optical fan-out device having an input port and a plurality of output ports, and an outer layer of optical fan-in devices, each optical fan-in device having an output port and a plurality of input ports. The method includes the steps of: adding at least one inner layer of optical devices disposed between the outer layer of optical fan-out devices and the outer layer of optical fan-in devices, and connecting at least one output port of an optical fan-out device in the outer layer of optical fan-out devices to an input port of an optical device in the at least one inner layer, and connecting at least one output port of an optical device in the at least one inner layer to an input port of an optical fan-in device in the outer layer of optical fan-in devices. The at least one inner layer of optical devices includes at least one WSS.

In one implementation, the method includes arranging a plurality of optical fan-out devices in the at least one inner layer in a cascade with respect to the outer layer of optical fan-out devices, each of the fan-out devices in the at least one inner layer comprising an input port and a plurality output ports.

In an alternative implementation, the method includes arranging a plurality of optical fan-in devices in the at least one inner layer in a cascade with respect to the outer layer of optical fan-in devices, each of the fan-in devices in the at least one inner layer comprising a plurality of input ports and an output port.

In another expedient, the at least one inner layer comprises a first inner layer and a second inner layer of optical devices, and the first inner layer of optical devices comprises a plurality of optical fan-out devices arranged in a cascade with respect to the outer layer of optical fan-out devices, each of the fan-out devices in the first inner layer comprising an input port and a plurality output ports; and the second inner layer of optical devices comprises a plurality of optical fan-in devices arranged in a cascade with respect to the outer layer of optical fan-in devices, each of the fan-in devices in the second inner layer comprising a plurality of input ports and an output port. In this case, the method of upgrading the ROADM further comprises: connecting each of the optical fan-out devices in the outer-layer to an optical fan-out device in the first inner layer, an optical fan-in device in the second inner layer, or an optical fan-in device in the outer layer of optical fan-in devices, and connecting each of the optical fan-in devices in the outer layer to an optical fan-in device in the second inner layer, an optical fan-out device in the first inner layer, or an optical fan-out device in the outer layer of optical fan-out devices.

In accordance with another aspect of the invention, there is provided a method for upgrading a WSXC including at least one layer of optical fan-out devices and a first and second layer of optical fan-in devices, each optical fan-out device connected to a plurality of optical fan-in devices, and each optical fan-in device in the first layer connected to at least one optical fan-out device, and each optical fan-in device in the first layer initially having no open input port, and at least one optical fan-in device in the second layer initially having at least one open input port. The method comprises: establishing at least one new connection from a fan-out device to an input port on the second layer of fan-in devices; shifting signals from an input port on the first layer of fan-in devices to the newly-connected input port on the second layer of fan-in devices, freeing up an input port on a fan-in device in the first layer; removing the old connection to the newly-freed input port; and adding a new fan-in device to the second layer of fan-in devices, the new fan-in device coupled to the newly-freed port of the fan-in device in the first layer.

In accordance with yet another aspect of the invention, there is provided a method for upgrading a WSXC including at least one layer of optical fan-in devices and a first and second layer of optical fan-out devices, each optical fan-in device connected to a plurality of optical fan-out devices, and each optical fan-out device in the first layer connected to at least one optical fan-in device, and each of the optical fan-out devices in the first layer initially having no open output port, and at least one optical fan-out device in the second layer initially having at least one open output port. The method comprises: establishing at least one new connection from a fan-in device to an output port on the second layer of fan-out devices; shifting signals from an output port on the first layer of fan-out devices to an output port on the second layer of fan-out devices, freeing up an output port on a fan-out device in the first layer; removing the old connection to the newly-freed port; and adding a new fan-out device to the second layer of fan-out devices, the new fan-out device coupled to the newly-freed port of the fan-out device in the first layer.

These aspects of the invention and further advantages thereof will become apparent to those skilled in the art as the present invention is described with particular reference to the accompanying drawings

### BRIEF DESCRIPTION OF THE DRAWINGS

FIG. 1a is a schematic of an exemplary prior art 3-degree ROADM with steerable add/drop, based on a WSXC;

FIG. 1b is a schematic of an exemplary 3-degree ROADM with fixed add/drop, based on a WSXC;

FIG. 2 is a schematic of an exemplary prior art WSXC in the ROADM of the type shown in FIG. 1b;

FIG. 3 is a schematic of an exemplary prior art multi-degree ROADM utilizing power splitters and WSSs;

FIG. 4 is a schematic of an exemplary prior art multi-degree ROADM using all WSSs;

FIG. 5 is a schematic of an illustrative three-layer 4-degree WSXC in an initial deployment accordance with aspects of the invention;

FIG. 6 is a schematic of a 5-degree WSXC that has been upgraded from the 4-degree ROADM shown in FIG. 5;

FIG. 7 is a schematic of another illustrative three-layer 4-degree WSXC in an initial deployment in accordance with aspects of the invention;

FIG. 8 is a schematic of a 5-degree WSXC that has been upgraded from the 4-degree WSXC shown in FIG. 7;

FIGS. 9-13 are schematics of an exemplary upgrade process in accordance with aspects of the invention for converting a three-layer 4-degree WSXC (FIG. 9) to a 5-degree WSXC (FIG. 13);

FIGS. 14-16 are schematics of an exemplary upgrade process in accordance with aspects of the invention for converting an initial deployment of a 2-degree WSXC (FIG. 14) to a 3-degree WSXC (FIG. 15), to a 6-degree WSXC (FIG. 16), with two inner layers of optical fan-out and fan-in devices;

FIG. 17 is a schematic of a WSXC including a plurality of optical amplifiers in one embodiment; and

FIG. 18 is a schematic of a WSXC including a plurality of optical amplifiers in an another embodiment

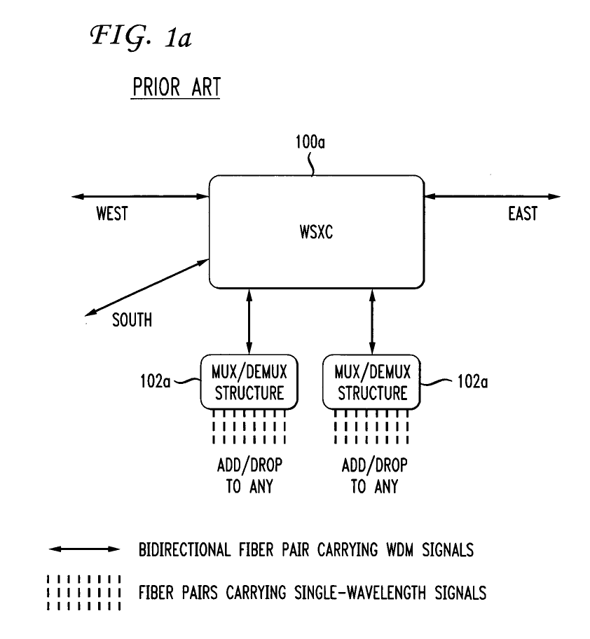

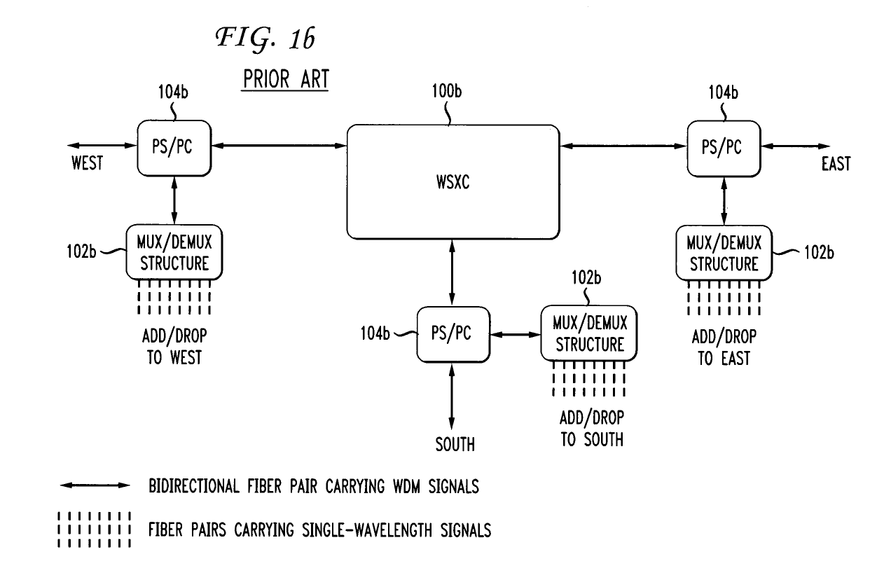

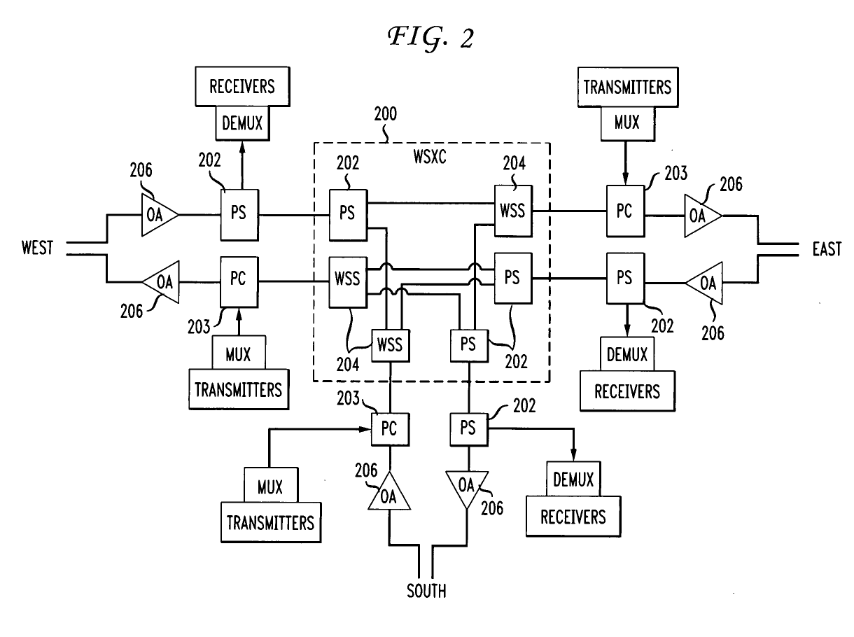

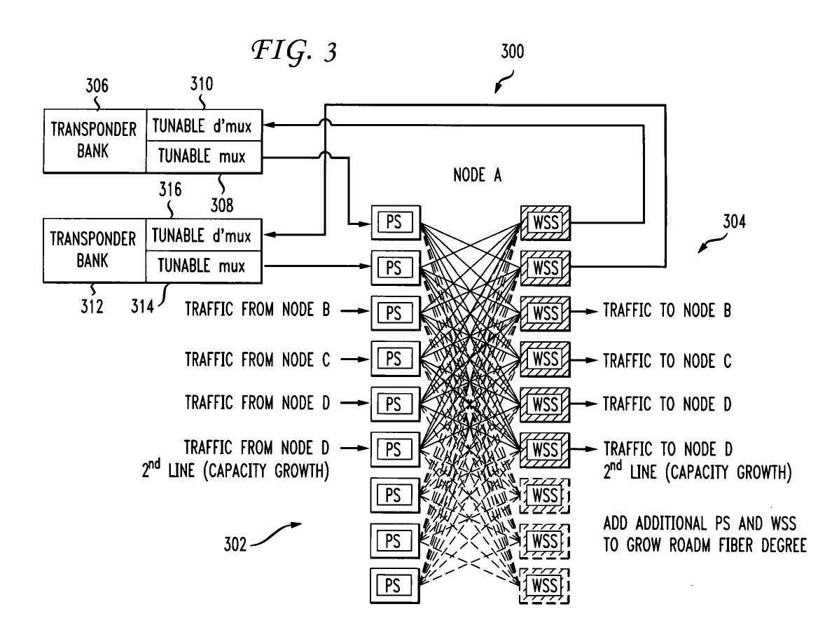

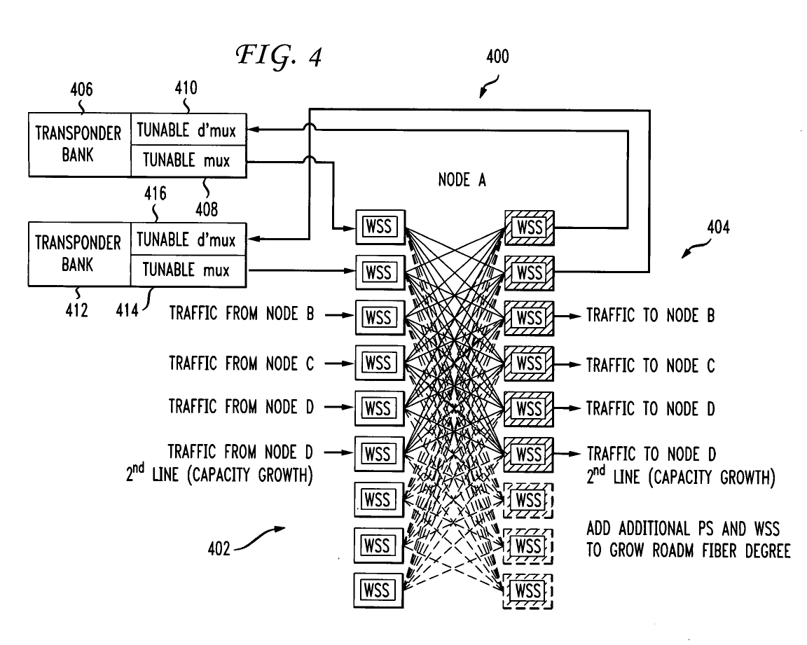

### DETAILED DESCRIPTION OF THE INVENTION

Embodiments of the invention will be described with reference to the accompanying drawing figures wherein like numbers represent like elements throughout to the extent possible. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein are meant to encompass the items listed thereafter and equivalents thereof as well as additional items.

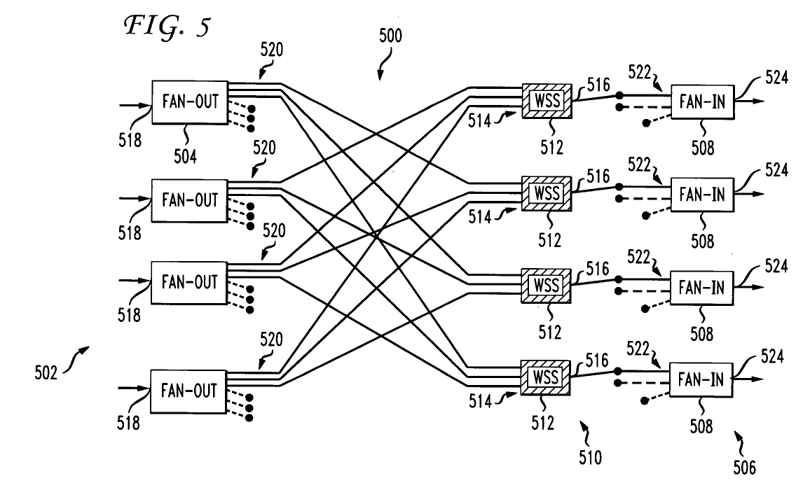

Referring to FIG. 5, there is depicted a schematic of an illustrative WSXC 500 in an initial deployment in accordance with an aspect of the present invention. ROADM 500 comprises an outer layer 502 of 1×M optical “fan-out” devices (i.e., power splitters or wavelength selective switches (WSSs)) 504 and an outer layer 506 of P×1 optical “fan-in” devices (i.e., power combiners or WSSs) 508. An inner layer 510 of N×1 optical fan-in devices, comprising a plurality of WSSs 512, is arranged in a cascade with respect to the outer layer 506 of optical fan-in devices 508. In the depicted embodiment, M=6, P=3, and N=3 for clarity, but it will be understood that this arrangement may be implemented with any integers N, P, and M. A WSS is an optical device that routes different spectral components from the desired input port(s) to the desired output port(s) without optical-to-electrical-to-optical conversion. In the embodiment shown in FIG. 5, each WSS 512 is arranged with a plurality of input ports 514 and a single output port 516. Each of the fan-out devices 504 has an input port 518 and a plurality of output ports 520, with a 1×6-port fan-out device shown. In the initial deployment of the illustrative WSXC 500, there are three unused ports on each fan-out device 504 as indicated by the dotted lines in the schematic. The output ports 520 of each fan-out device 504 in the outer layer 502 couple the fan-out device 504 to a plurality of WSSs 512 in the inner layer 510 via the respective input ports 514. Each fan-in device 508 has a plurality of input ports 522 and an output port 524. One of the input ports 522 of each fan-in device 508 in the outer layer 506 is coupled to an output port 516 of a WSS 512 in the inner layer. In the example shown, there are two unused input ports 522 on each fan-in device 508 in the outer layer 506 for future growth as shown by the dotted lines. Also, it will be understood by those of skill in the art that the fan-out devices 504 in the outer layer 502 may be coupled to either the WSSs 512 in the inner layer or the fan-in devices 508 in the outer layer 506. Similarly, the fan-in devices 508 in the outer layer 506 may be coupled to either the WSSs 512 in the inner layer 510, or the fan-out devices 504 in the outer layer 502.

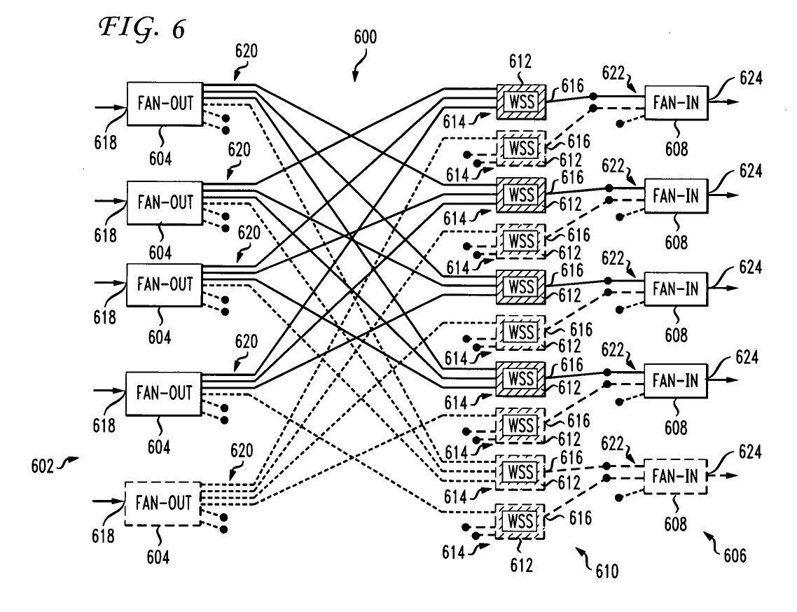

FIG. 6 is a schematic of a five-degree WSXC 600, which has been expanded from the 4-degree ROADM depicted in FIG. 5. In this embodiment, an additional fan-out device 604 has been added to the outer layer 602 of fan-out devices 604, and an additional fan-in device 608 has been added to the outer layer 606 of fan-in devices 608. Additional WSSs 612 have been added to the inner layer 610 of fan-in devices 612. The new connections and hardware are shown with dashed lines in FIG. 6. Similarly, the open output ports 620 of the fan-out devices 604, open input ports 614 of the WSSs 612, and open input ports 622 of the fan-in devices 608 for further growth are shown as the dotted lines in FIG. 6. Note, all other connections are similar to those shown in FIG. 5, where like numbers represent like elements.

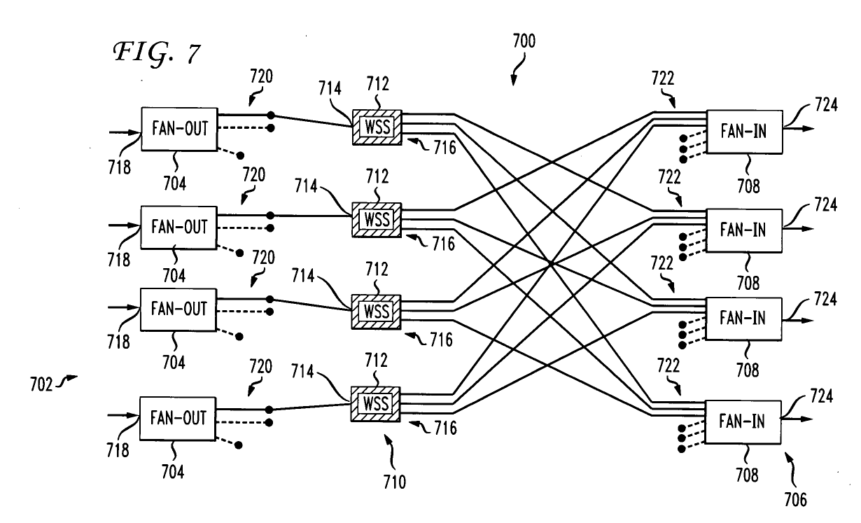

FIG. 7 is a schematic of a growable WSXC 700 in an initial deployment that is similar to the WSXC 500 of FIG. 5. However, in this embodiment an inner layer 710 of 1×N fan-out WSSs 712 are provided in lieu of the fan-in WSSs 512. Here the plurality of WSSs 712 is arranged in a cascade with respect to the outer layer 702 of fan-out devices 704. Each WSS 712 is arranged with an input port 714 and a plurality of output ports 716. Each of the fan-out devices 704 has an input port 718 and a plurality of output ports 720, with a 1×3-port switch shown. Each fan-in device 708 has a plurality of input ports 722 and an output port 724. In the initial deployment of the illustrative ROADM 700, there are three unused ports 722 on each fan-in device 708 as indicated by the dotted lines in the schematic. The output ports 720 of each fan-out device 704 in the outer layer 702 couple the fan-out device 704 to a WSS 712 in the inner layer 710 via the respective input ports 714. Each of the output ports 716 of WSS 712 is connected to an input port 722 of a fan-in device 708 in the outer layer 706. In the example shown, there are two unused output ports 720 on each fan-out device 704 in the outer layer 702, and three unused input ports 722 on each fan-in device 708 in the outer layer 706 for future growth as shown by the dotted lines.

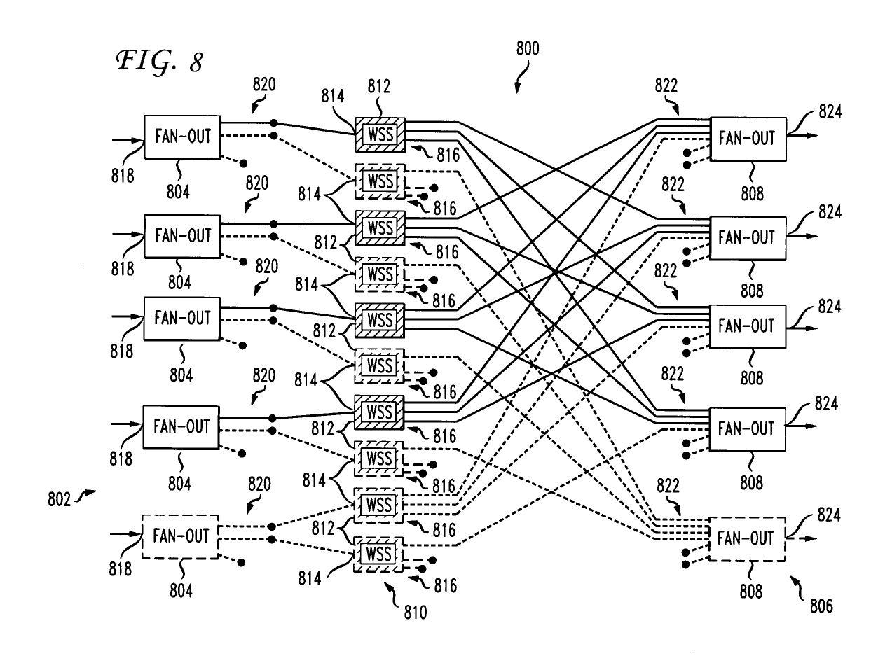

FIG. 8 is a schematic of a five-degree WSXC 800, which has been expanded from the 4-degree WSXC 700 depicted in FIG. 7. In this embodiment, an additional fan-out device 804 has been added to the outer layer 802 of fan-out devices 804, an additional fan-in device 808 has been added to the outer layer 806 of fan-in devices 808. Additional WSSs 812 have been added to the inner layer 810 of fan-out devices. The new connections and hardware are depicted with dashed lines in FIG. 6. Similarly, the open output ports 820 of the fan-out devices 804, open output ports 816 of the WSSs 812, and open input ports 822 of the fan-in devices 808 to enable further growth, are shown as dotted lines in FIG. 8. All other connections are similar to those shown in FIG. 7, wherein like numbers represent like elements.

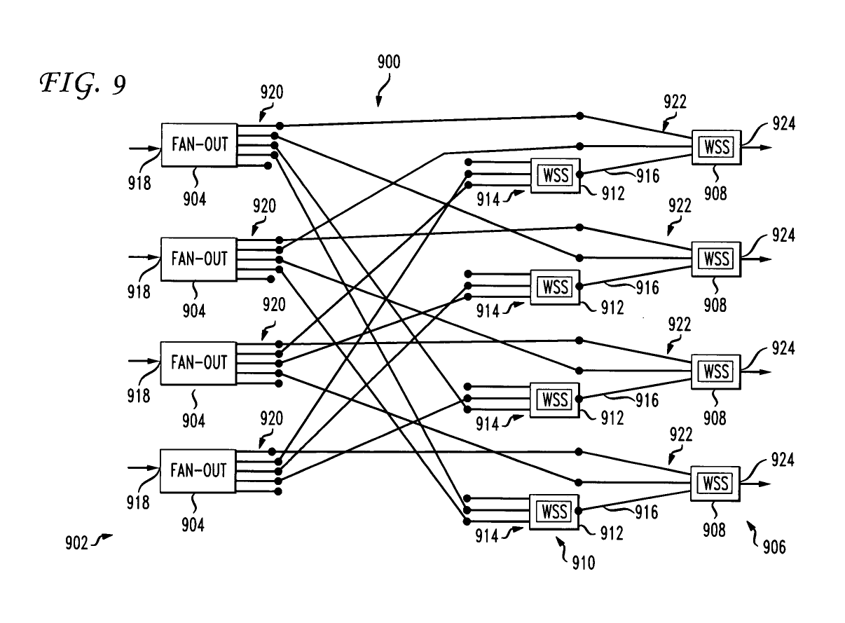

FIGS. 9-13 are schematics that depict a methodology for upgrading a WSXC of the type shown in FIG. 5 when all ports of the outer fan-in layer are full. The method involves rolling an existing connection to a new connection between inner layers, then removing the old connection to the outer layer, freeing up a port on the outer layer, and adding a new WSS to the inner layer of fan-in devices. FIG. 9 illustrates the WSXC 900 in an initial deployment where all input ports 922 of fan-in devices (WSSs) 908 in the outer layer 906 are full. In this example, each WSS 908 is coupled to a fan-in WSS 912 in the inner layer 910 and a fan-out device 904 in the outer layer 902. Using a similar convention to that employed in FIG. 5, each fan-out device 904 in layer 902 has an input port 918 and a plurality of output ports 920, where one of the output ports 920 is free. Each WSS 912 has a plurality of input ports 914, one of which is free, and an output port 916. Each fan-in device 908 has a plurality of input ports 922 and an output port 924.

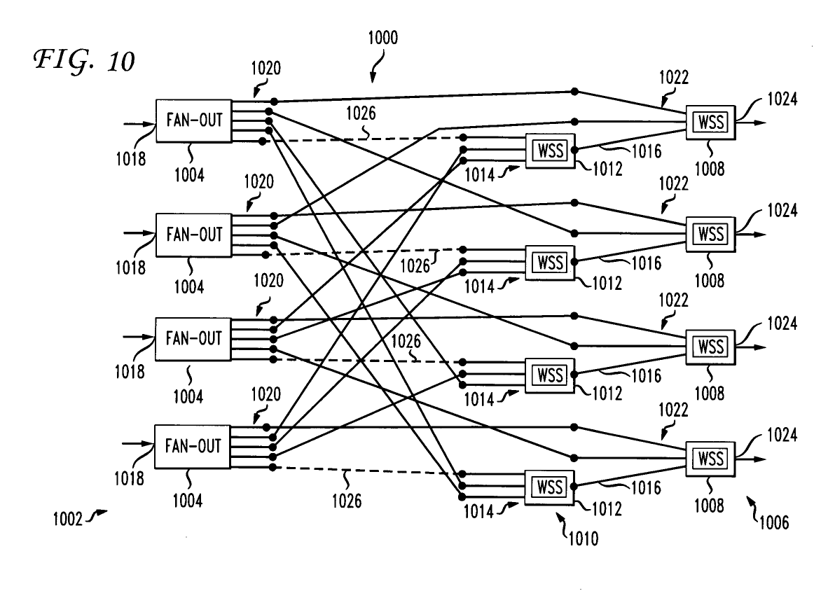

In FIG. 10, a first step of the upgrade is illustrated by WSXC 1000, where a new connection is added between each of the fan-out devices 1004 in the first layer 1002 and the fan-in devices 1012 in the inner layer 1010. Using a similar convention to FIG. 9, each fan-out device 1004 in the outer layer 1002 includes an input port 1018 and a plurality of output ports 1020, each WSS 1012 in the inner layer 1010 includes a plurality of input ports 1014 and an output port 1016, and each WSS 1008 in the outer layer 1006 includes a plurality of input ports 1022 and an output port 1024. The new connection 1026 is added by connecting a previously open output port of each fan-out device 1004 to a previously open input port 1014 of each WSS 1012.

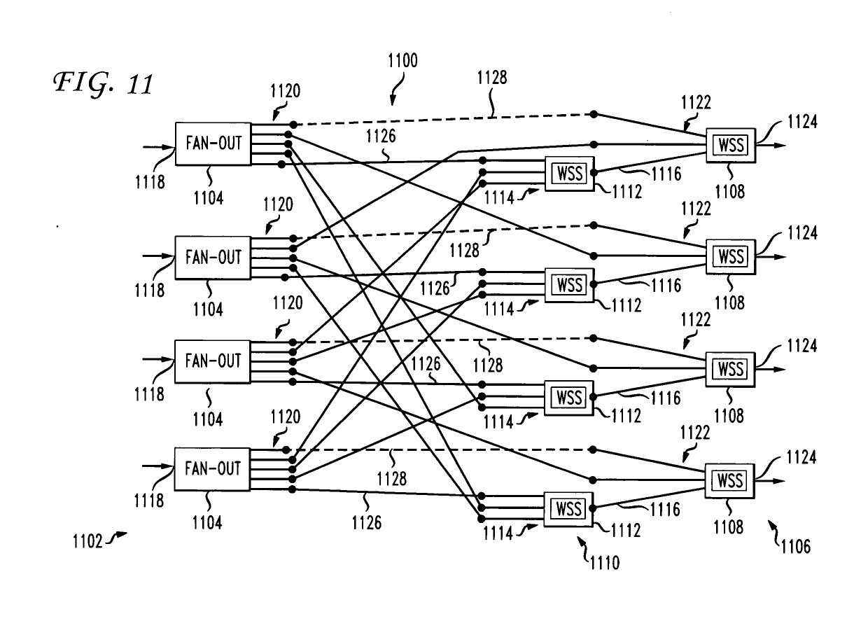

In FIG. 11, a second step of the upgrade is illustrated by WSXC 1100, where open ports are created in the outer layer of fan-in devices. Using a similar convention to FIGS. 9 and 10, each fan-out device 1104 in the outer layer 1102 includes an input port 1118 and a plurality of output ports 1120, each WSS 1112 in the inner layer 1110 includes a plurality of input ports 1114 and an output port 1116, and each WSS 1108 in the outer layer 1106 includes a plurality of input ports 1122 and an output port 1124. The connection 1126 that was previously added between each fan-out device 1104 and WSS 1112 enables the removal of a connection 1128 (indicated by the dotted lines in FIG. 11) between an output port 1120 of each fan-out device 1104 and an input port 1122 of each WSS 1108 in the outer layer 1116, thereby freeing up an input port 1122 in each WSS 1108 in the outer layer 1116.

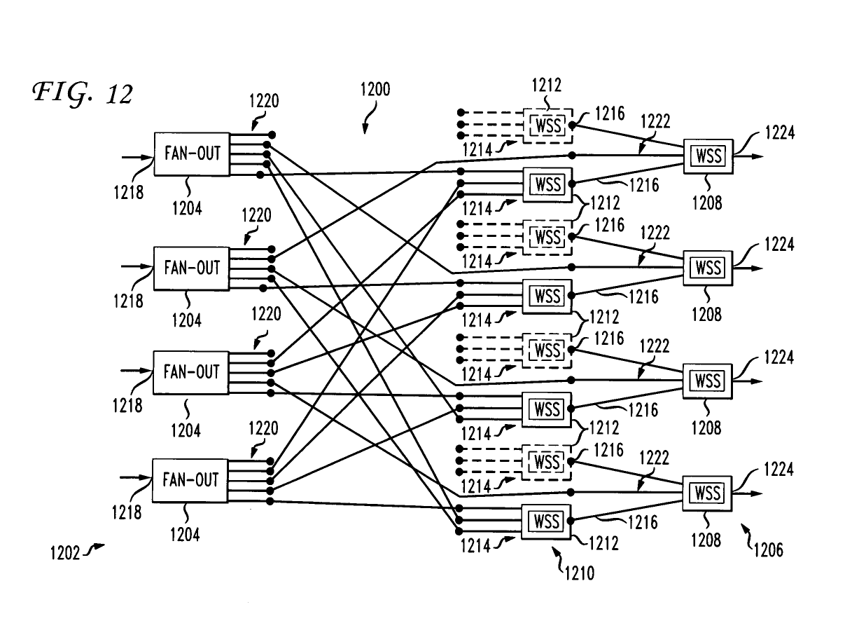

In FIG. 12, a third step of the upgrade is illustrated by WSXC 1200, where additional WSSs 1212 are added to the inner layer 1210 of WSSs. Using a similar convention to FIGS. 9-11, each fan-out device 1204 in the outer layer 1202 includes an input port 1218 and a plurality of output ports 1220, each WSS 1212 in the inner layer 1210 includes a plurality of input ports 1214 and an output port 1216, and each WSS 1208 in the outer layer 1206 includes a plurality of input ports 1222 and an output port 1224. Additional WSSs 1212 as shown by the dashed lines have been added to the inner layer 1210 by connecting the respective output ports 1216 thereof to the open output ports 1222 on the WSSs 1208 in the outer layer 1206.

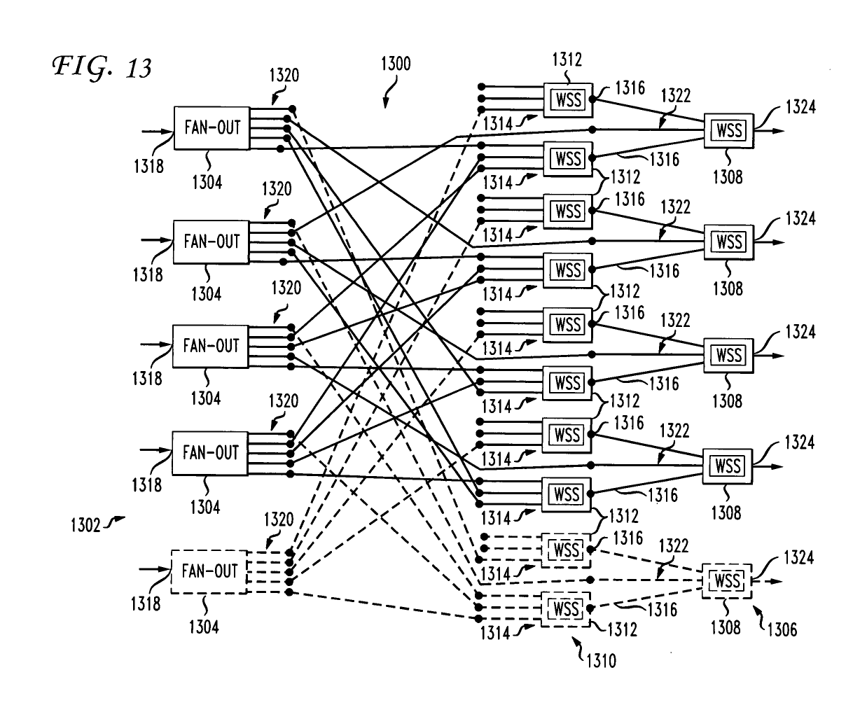

In FIG. 13, a fourth step of the upgrade is illustrated by WSXC 1300, where a new row of devices are added to increase degrees of the ROADM from four to five. Using a similar convention to FIGS. 9-12, each fan-out device 1304 in the outer layer 1302 includes an input port 1318 and a plurality of output ports 1320, each WSS 1312 in the inner layer 1310 includes a plurality of input ports 1314 and an output port 1316, and each WSS 1308 in the outer layer 1306 includes a plurality of input ports 1322 and an output port 1324. An additional fan-out device 1304 as shown by the dashed lines has been added to the outer layer 1302 of fan-out devices, additional WSSs 1312 have been added to the inner layer 1312 of fan-in devices, and an additional WSS 1308 has been added to the outer layer 1306 of fan-in devices. New connections between the fan-out devices 1304 in the first layer 1302 and the WSSs 1312 in the inner layer 1310, and a new connection between a fan-out device 1304 and a WSS 1308 in the outer layer 1306 are shown by the dashed lines and indicated at 1326. This exemplary process transforms the 4-degree WSXC 900 shown in FIG. 9 to the 5-degree WSXC 1300 shown in FIG. 13. It will be appreciated by those skilled in the art that a similar methodology may be employed to upgrade a three-layer ROADM comprising an inner layer of optical fan-out devices (instead of fan-in devices) that are arranged in a cascade with respect to the outer layer of fan-out devices as represented by the embodiment of FIG. 7.

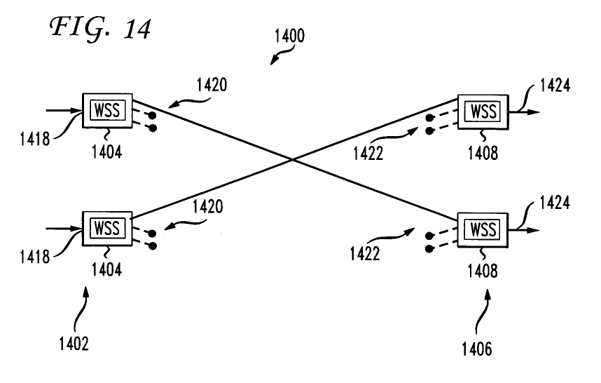

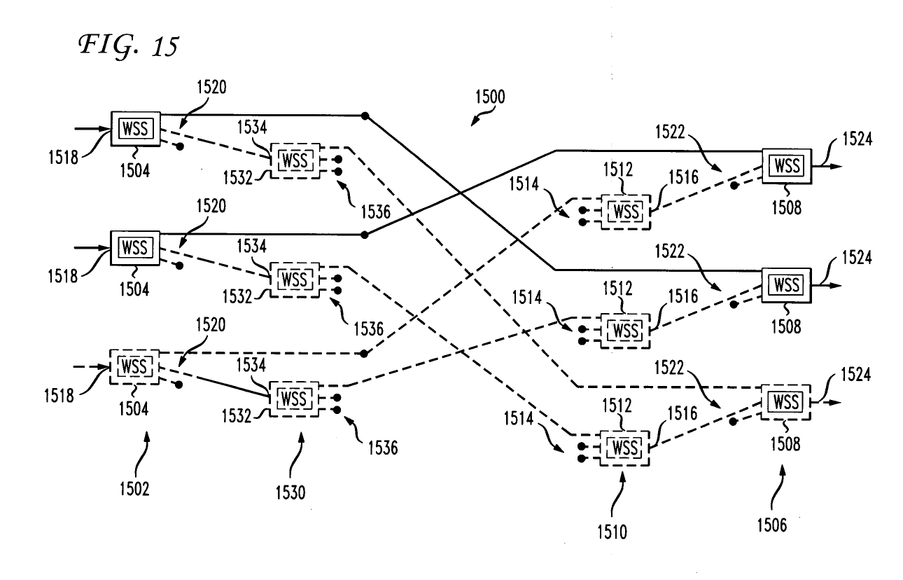

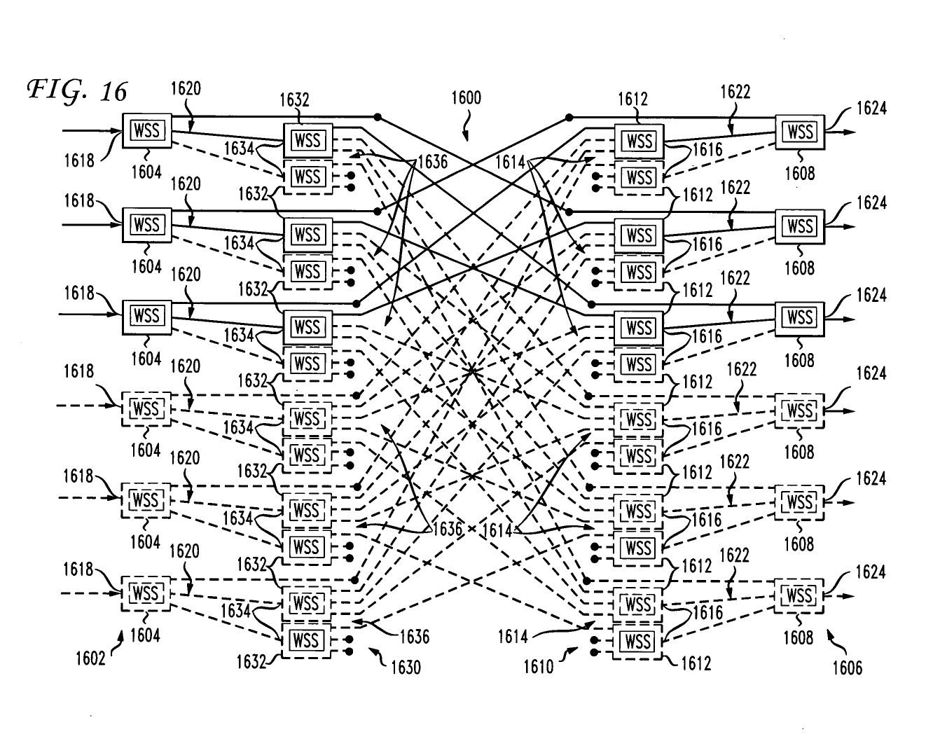

FIGS. 14-16 depict an illustrative growth path from a 2-degree WSXC 1400 in FIG. 14, to a 3-degree WSXC 1500 in FIG. 15, to a 6-degree WSXC 1600 in FIG. 16 in accordance with another exemplary embodiment that utilizes an inner layer of optical fan-out devices and an inner layer of optical fan-in devices.

FIG. 14 depicts an initial deployment of the 2-degree WSXC1400, which comprises a first or “outer” layer 1402 of fan-out devices (WSSs) 1404, and a second or “outer” layer 1406 of fan-in devices (WSSs) 1408. Each WSS 1404 comprises an input port 1418 and a plurality of output ports 1420, and each WSS 1408 comprises a plurality of input ports 1422 and an output port 1424. In the initial deployment, there are two free output ports 1420 on each WSS 1404 and two free input ports 1422 on each WSS 1408.

FIG. 15 illustrates a growth path to a 3-degree WSXC 1500, which comprises an outer layer 1502 of fan-out devices (WSSs) 1504, an outer layer 1506 of fan-in devices (WSSs) 1508, an inner layer 1510 of fan-in devices (WSSs) 1512 arranged in a cascade with respect to outer layer 1506, and an inner layer 1530 of fan-out devices (WSSs) 1532 arranged in a cascade with respect to outer layer 1502. The hardware and connections utilized in the upgrade are shown by dashed lines. Each WSS 1504 includes an input port 1518 and a plurality of output ports 1520, each WSS 1508 includes a plurality of input ports 1522 and an output port 1524, each WSS 1512 includes a plurality of input ports 1514 and an output port 1516, and each WSS 1532 includes an input port 1534 and a plurality of output ports 1536. As shown, the WSSs 1504 in outer layer 1502 couple to either a fan-out WSS 1532 in layer 1530, a fan-in WSS 1512 in layer 1510, or a fan-in WSS 1508 in layer 1506. Similarly, a fan-in WSS 1508 couples to either a fan-in WSS 1512 in layer 1510, a fan-out WSS 1532 in layer 1530 or a fan-out WSS 1504 in layer 1502. The free input ports 1514, 1522 on the fan-in devices and output ports 1520, 1536 on fan-out devices to enable future growth are depicted by the dotted lines in the drawing.

FIG. 16 depicts the growth path from the 3-degree WSXC 1500 shown in FIG. 15 to a 6-degree WSXC 1600. The WSXC 1600 comprises an outer layer 1602 of fan-out devices (WSSs) 1604, an outer layer 1606 of fan-in devices (WSSs) 1608, an inner layer 1610 of fan-in devices (WSSs) 1612 arranged in a cascade with respect to outer layer 1606, and an inner layer 1630 of fan-out devices (WSSs) 1632 arranged in a cascade with respect to outer layer 1602. Each WSS 1604 includes an input port 1618 and a plurality of output ports 1620, each WSS 1608 includes a plurality of input ports 1622 and an output port 1624, each WSS 1612 includes a plurality of input ports 1514 and an output port 1516, and each WSS 1532 includes an input port 1534 and a plurality of output ports 1536. In this upgrade, additional fan-out WSSs 1604 have been added to the outer layer 1602, additional fan-out WSSs 1632 have been added to the inner layer 1630, additional fan-in WSSs 1612 have been added to the inner layer 1610, and additional fan-in WSSs 1608 have been added to the outer layer 1606. The newly added hardware and connections therebetween are again illustrated by dashed lines. The free input ports 1614, 1622 on the fan-in devices and output ports 1620, 1636 on fan-out devices to enable future growth are depicted by the dotted lines in the drawing.

Additional layers of fan-in and fan-out devices may be connected to the edge layers indirectly, through intermediate layers. By this iterative process of layering, a ROADM of arbitrarily large degree may be constructed, subject only to practical limitations such as optical loss (even loss can be overcome with optical amplifiers, but these add to the cost, and can degrade the optical signal to noise ratio of the signal, which can have negative system implications).

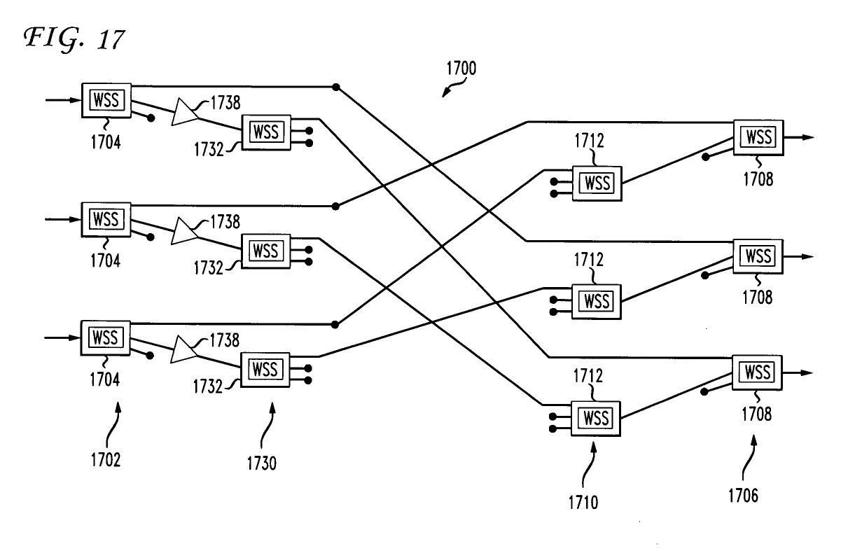

FIG. 17 is a schematic of a WSXC 1700 similar to the WSXC 1500 shown in FIG. 15, but where a plurality of optical amplifiers 1738 are disposed between an outer layer 1702 of fan-out devices (WSSs) 1704 and an inner layer 1730 of fan-out devices (WSSs) 1732. The connections between the WSSs 1712 and WSSs 1708 in the layers of fan-in devices are not amplified.

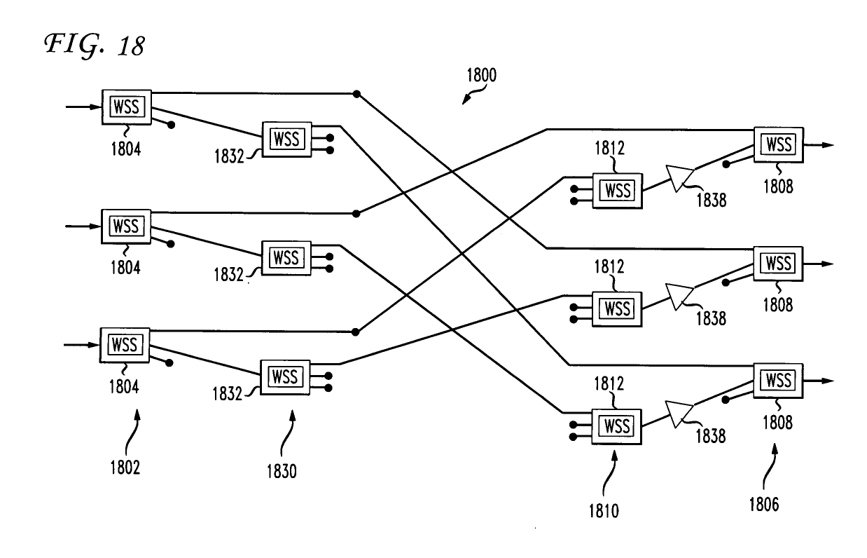

FIG. 18 is a schematic of a WSXC 1800 similar to the WSXC 1700 shown in FIG. 17, but where a plurality of optical amplifiers 1838 are disposed between an inner layer 1810 of fan-in devices 1812 and outer layer 1806 of fan-in devices 1808. The connections between the WSSs 1804 in the outer layer 1802 of fan-out devices and the WSSs 1832 in the inner layer 1830 of fan-out devices, and the connections between the WSSs 1804 in the outer layer of fan-out devices and WSSs 1808 in the outer layer 1806 of fan-in devices are not amplified. It will be appreciated by those skilled in the art that amplifiers may be placed at either the input side (FIG. 17), the output side (FIG. 18), at locations proximal to both the input and output sides, or at the center of the fabric between either the inner and outer layers or between an outer layer and an inner layer on the opposite side if necessary.

The above-described WSXC expedients also have the ability to provide for enhanced multicasting. Optical multicasting is the capability to divide the input power on individual wavelengths and to simultaneously deliver those signals to multiple ports. Present WSS have limited multicast capability, with the maximum number of multicast outputs K typically much smaller (2 or 4) than the number of ports N. By providing two layers of WSSs, the number of simultaneous multicast outputs can be increased to K². For three layers, the multicast output count would be even larger. The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

1. A wavelength-selective crossconnect (WSXC), comprising:
an outer layer of optical fan-out devices, each of the outer layer of optical fan-out devices having an input port and a plurality of output ports;
an outer layer of optical fan-in devices, each of the outer layer of optical fan-in devices having an output port and a plurality of input ports; and
at least one inner layer of optical devices disposed between the outer layer of optical fan-out devices and the outer layer of optical fan-in devices, wherein at least one output port of an optical fan-out device in the outer layer of optical fan-out devices is connected to an input port of an optical device in the at least one inner layer, and at least one output port of an optical device in the at least one inner layer is connected to an input port of an optical fan-in device in the outer layer of optical fan-in devices;
wherein, the at least one inner layer of optical devices includes at least one wavelength selective switch.

2. The WSXC of claim 1, wherein the total number of output ports from the outer layer of optical fan-in devices is greater than the number of output ports in any of the optical fan-out devices in the ROADM, plus one.

3. The WSXC of claim 1, wherein the total number of input ports to the outer layer of optical fan-out devices is greater than the number of input ports in any of the optical fan-in devices in the ROADM, plus one.

4. The WSXC of claim 1, wherein the outer layer of optical fan-out devices comprises a plurality of wavelength selective switches.

5. The WSXC of claim 1, wherein the outer layer of optical fan-in devices comprises a plurality of wavelength selective switches.

6. The WSXC of claim 1, wherein the at least one inner layer comprises a plurality of optical fan-out devices arranged in a cascade with respect to the outer layer of optical fan-out devices, each of the fan-out devices in the at least one inner layer comprising an input port and a plurality of output ports.

7. The WSXC of claim 1, wherein the at least one inner layer comprises a plurality of optical fan-in devices arranged in a cascade with respect to the outer layer of optical fan-in devices, each of the fan-in devices in the at least one inner layer comprising a plurality of input ports and an output port.

8. The WSXC of claim 1, wherein the at least one inner layer comprises a first inner layer and a second inner layer of optical devices:
the first inner layer of optical devices comprising a plurality of optical fan-out devices arranged in a cascade with respect to the outer layer of optical fan-out devices, each of the fan-out devices in the first inner layer comprising an input port and a plurality output ports;
the second inner layer of optical devices comprising a plurality of optical fan-in devices arranged in a cascade with respect to the outer layer of optical fan-in devices, each of the fan-in devices in the second inner layer comprising a plurality of input ports and an output port,
each of the optical fan-out devices in the outer-layer being coupled to an optical fan-out device in the first inner layer, an optical fan-in device in the second inner layer, or an optical fan-in device in the outer layer of optical fan-in devices, and each of the optical fan-in devices in the outer layer being coupled to an optical fan-in device in the second inner layer, an optical fan-out device in the first inner layer, or an optical fan-out device in the outer layer of optical fan-out devices.

9. The WSXC of claim 6, wherein the first inner layer of optical fan-out devices comprises a plurality of wavelength selective switches.

10. The WSXC of claim 8, wherein the first inner layer of optical fan-out devices comprises a plurality of wavelength selective switches.

11. The WSXC of claim 7, wherein the inner layer of optical fan-in devices comprises a plurality of wavelength selective switches.

12. The WSXC of claim 7, wherein the second inner layer of optical fan-in devices comprises a plurality of wavelength selective switches.

13. A method for upgrading a wavelength-selective crossconnect (WSXC) comprising an outer layer of optical fan-out devices, each optical fan-out device having an input port and a plurality of output ports, and an outer layer of optical fan-in devices, each optical fan-in device having an output port and a plurality of input ports, comprising the steps of:
adding at least one inner layer of optical devices disposed between the outer layer of optical fan-out devices and the outer layer of optical fan-in devices, and connecting at least one output port of an optical fan-out device in the outer layer of optical fan-out devices to an input port of an optical device in the at least one inner layer, and connecting at least one output port of an optical device in the at least one inner layer to an input port of an optical fan-in device in the outer layer of optical fan-in devices;
wherein, the at least one inner layer of optical devices includes at least one wavelength selective switch.

14. The method of claim 13, further comprising:
arranging a plurality of optical fan-out devices in the at least one inner layer in a cascade with respect to the outer layer of optical fan-out devices, each of the fan-out devices in the at least one inner layer comprising an input port and a plurality output ports.

15. The method of claim 13, further comprising:
arranging a plurality of optical fan-in devices in the at least one inner layer in a cascade with respect to the outer layer of optical fan-in devices, each of the fan-in devices in the at least one inner layer comprising a plurality of input ports and an output port.

16. The method of claim 13, wherein the at least one inner layer comprises a first inner layer and a second inner layer of optical devices, and the first inner layer of optical devices comprises a plurality of optical fan-out devices arranged in a cascade with respect to the outer layer of optical fan-out devices, each of the fan-out devices in the first inner layer comprising an input port and a plurality of output ports; and the second inner layer of optical devices comprises a plurality of optical fan-in devices arranged in a cascade with respect to the outer layer of optical fan-in devices, each of the fan-in devices in the second inner layer comprising a plurality of input ports and an output port, and the method further comprises:
connecting each of the optical fan-out devices in the outer-layer to an optical fan-out device in the first inner layer, an optical fan-in device in the second inner layer, or an optical fan-in device in the outer layer of optical fan-in devices, and connecting each of the optical fan-in devices in the outer layer to an optical fan-in device in the second inner layer, an optical fan-out device in the first inner layer, or an optical fan-out device in the outer layer of optical fan-out devices.

17. A method for upgrading a wavelength-selective crossconnect (WSXC) including at least one layer of optical fan-out devices and a first and second layer of optical fan-in devices, each optical fan-out device connected to a plurality of optical fan-in devices, and each optical fan-in device in the first layer connected to at least one optical fan-out device, and each optical fan-in device in the first layer initially having no open input port, and at least one optical fan-in device in the second layer initially having at least one open input port, the method comprising:
establishing at least one new connection from a fan-out device to an input port on the second layer of fan-in devices;
shifting signals from an input port on the first layer of fan-in devices to the newly-connected input port on the second layer of fan-in devices, freeing up an input port on a fan-in device in the first layer;
removing the old connection to the newly-freed input port; and
adding a new fan-in device to the second layer of fan-in devices, the new fan-in device coupled to the newly-freed port of the fan-in device in the first layer.

18. A method for upgrading a wavelength-selective crossconnect (WSXC) including at least one layer of optical fan-in devices and a first and second layer of optical fan-out devices, each optical fan-in device connected to a plurality of optical fan-out devices, and each optical fan-out device in the first layer connected to at least one optical fan-in device, and each of the optical fan-out devices in the first layer initially having no open output port, and at least one optical fan-out device in the second layer initially having at least one open output port, the method comprising:
establishing at least one new connection from a fan-in device to an output port on the second layer of fan-out devices;
shifting signals from an output port on the first layer of fan-out devices to an output port on the second layer of fan-out devices, freeing up an output port on a fan-out device in the first layer;
removing the old connection to the newly-freed port; and
adding a new fan-out device to the second layer of fan-out devices, the new fan-out device coupled to the newly-freed port of the fan-out device in the first layer.
